(19) United States
(12) Patent Application Publication
(10) Pub. No.: US 2016/0004025 A1
(43) Pub. Date: Jan. 7, 2016

(54) OPTICAL FIBER SEISMIC SENSING CABLE

(71) Applicant: OFS FITEL, LLC, Norcross, GA (US)

(72) Inventors: Stefan Jost, Augsburg (DK); Jason Pedder, Chepstow (GB); Heng Ly, Stone Mountain, GA (US); Jacob Ulrik Petersen, Tune (DK)

(73) Assignee: OFS FITEL, LLC, Norcross, GA (US)

(21) Appl. No.: 14/766,841

(22) PCT Filed: Feb. 11, 2013
(86) PCT No.: PCT/US13/25582

§ 371 Date: Aug. 10, 2015

(51) Int. Cl. G02B 6/44; G02B 6/02

(52) U.S. Cl. CPC G02B 6/4427; G02B 6/4432; G02B 6/02033; G02B 6/4411; G02B 6/4495

(57) ABSTRACT

Described is an improved optical fiber cable specially adapted for seismic sensing. Compared with standard optical fiber cable, this improved optical fiber cable is reduced in size, lighter, and more flexible. These characteristics make the optical fiber cable more robust for reusable applications. Due to modifications in the design of the optical fibers, the size and weight of the seismic sensing cable may be substantially reduced. That allows longer lengths of seismic sensing cable, and more seismic sensor boxes, to be reeled on a given sized reel, and makes deployment of the seismic sensing cable faster, easier, and less expensive. A preferred cable design for reaching these objectives comprises multiple optical fibers, of a design just described, encased in a dual-layer optical fiber buffer encasement of acrylate resin.

### FIELD OF THE INVENTION

This invention relates to optical fiber cables used for seismic mapping of terrestrial or undersea geological formations.

### BACKGROUND OF THE INVENTION

Advanced techniques for seismic mapping of underground geological formations use multiple seismic sensor boxes deployed in a large x-y array spread over the area being surveyed. The sensor boxes are typically motion sensors, for example, accelerometers. In state of the art methods and systems the sensor boxes record seismic activity by converting detected motion to an optical signal. Optical signals from the seismic sensor boxes are transmitted to a base station where data from the sensor box array is collected and processed. Each seismic sensor box communicates with the base station over its dedicated optical fiber.

In a typical seismic sensor box array, a main optical fiber seismic sensing cable, many meters in length, is deployed over a portion of the land or undersea area being mapped. Many cables, arranged typically in a parallel array, may be used to cover the mapped area. For undersea mapping, the array of multiple cables may be towed over a seabed by an ocean going vessel.

A relative unique characteristic of seismic sensing optical fiber cables are that they are deployed and redeployed many times during the service life of the cable. This contrasts with most fiber optic cable, which is installed in one place and remains stationary for the service life of the cable. Thus this description refers to deployment rather than installation of seismic sensing cable.

In a typical seismic sensing cable, a large number of seismic sensor boxes are connected to a data acquisition unit via individual optical fibers. At suitable intervals along the seismic sensing cable a seismic sensor box is spliced to one of the optical fibers in the optical fiber cable. The optical fiber cable, with sensor boxes installed, is typically wound on a cable drum, and deployed by unwinding the optical fiber cable over the area being mapped. After mapping one area the optical fiber cable is rewound on the drum and the deployment process repeated at another location. Thus a typical optical fiber cable is wound and rewound many times during the service life of the cable. It will be understood that for this application special characteristics of the seismic sensing cable are paramount. These include size, weight, and flexibility. Improvements in seismic sensing cable, and seismic sensing cable deployment, represent significant advances in seismic technology.

### STATEMENT OF THE INVENTION

We have developed an improved optical fiber cable that is specially adapted for use in seismic sensing. Compared with standard optical fiber seismic cable, this improved cable is reduced in size, lighter, and more flexible. These characteristics make the seismic sensing cable more robust for reusable applications. Due to modifications in the design of the optical fibers in the cable, the size and weight of the seismic sensing cable is substantially reduced. That allows more efficient reeling of lengths of seismic sensing cable, and seismic sensor boxes, on a given sized drum, and makes deployment of the seismic sensing cable faster, easier, and less expensive. A preferred cable design for reaching these objectives comprises multiple optical fibers, of a special design, encased in a dual-layer optical fiber buffer encasement of acrylate resin. The buffer encasement comprises a compliant acrylate inner layer that protects the fibers and minimizes stress transfer to the fibers, and a hard, tough acrylate outer layer that provides crush resistance. One or more dual-layer optical fiber buffer encasements may wrapped with a reinforcing layer and encased in an outer protective jacket.

### BRIEF DESCRIPTION OF THE DRAWING

FIG. 1 is a representation of an optical fiber seismic sensing cable, showing the seismic sensor boxes attached to the optical fiber network;

FIG. 2 is a schematic representation of an optical fiber adapted specifically for seismic optical fiber cables;

FIG. 3 is a schematic view of a subunit of the optical fiber seismic sensing cable showing a dual-layer optical fiber buffer encasement; and

FIG. 4 is a schematic view of a large fiber count seismic sensing cable of the invention wherein a plurality of dual-layer optical fiber buffer encasements is cabled together.

### DETAILED DESCRIPTION

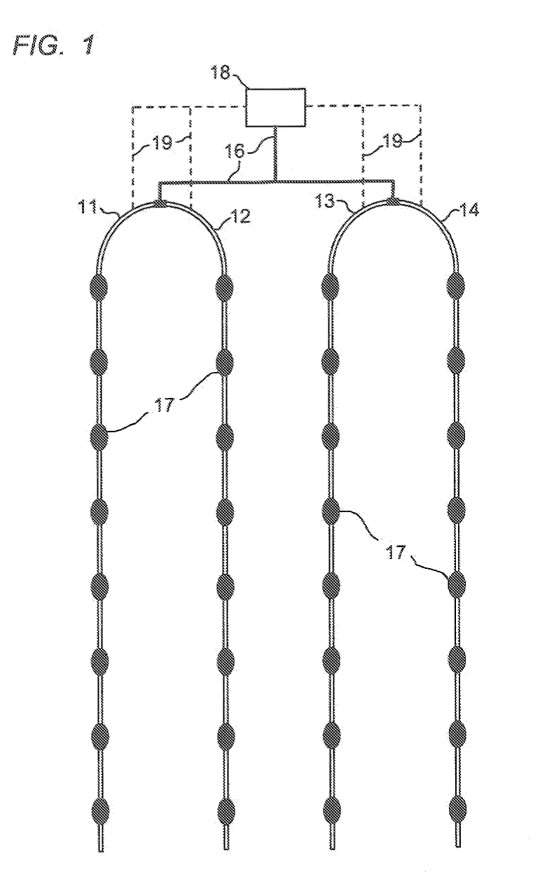

FIG. 1 illustrates in a generalized way the preferred application for the reduced size optical fiber cable of the invention. FIG. 1 shows an array of optical fiber seismic sensing cables 11, 12, 13, and 14, each carrying a plurality of seismic sensor boxes 17. The drawing is not to scale. Sensor boxes for sensing seismic data are typically accelerometers or other form of motion sensor. The spacing of the sensor boxes along the optical fiber cables is typically 2 to 30 meters, more commonly 5 to 15 meters. The optical fiber sensing cables may be attached to a towing harness, represented by 16, and the towing harness attached to a towing vehicle, represented in FIG. 1 by 18. The optical data from the multiple seismic sensors is transmitted to a data storage device typically located on the towing vehicle. Reference number 19 schematically shows the optical connections.

The data storage device is typically a computer that detects the optical signals and stores data representing the optical data. The data is processed by a data processor to produce the desired seismic map. The data storage device may include optical receivers or optical transceivers.

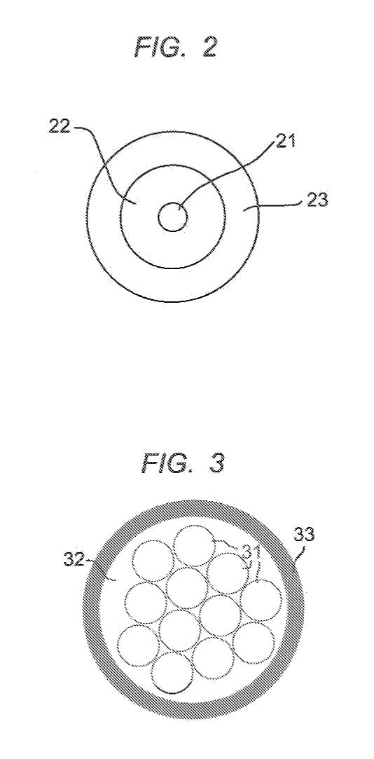

The optical fiber used in the optical fiber seismic sensing cable is optical fiber specially designed for this application. It is referred to here as seismic cable optical fiber (SCOF). It is shown schematically in FIG. 2, where 21 represents the core of the glass optical fiber, and 22 represents the cladding. The optical fiber coating is shown at 23. The core 21 is a single mode optical fiber core, with a diameter typically in the range of 4-10 microns. The core is preferably germanium-doped silica, and preferably has a high delta to reduce bending loss. The cladding 22 has a diameter of 75 to 85 microns. The small cladding diameter contributes to the goals of the invention. The coating may be a single coating, or a dual coating, but has a diameter of 170 microns or less, preferably 155-170 microns.

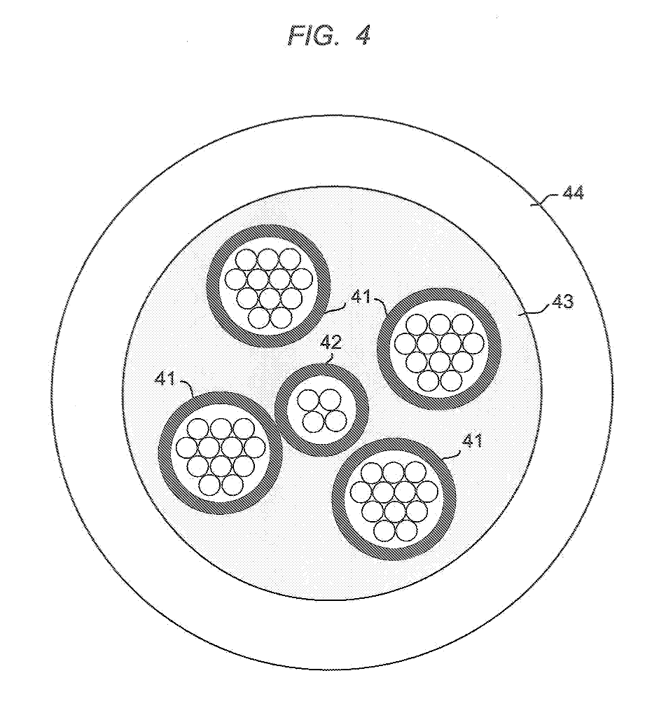

Referring to FIG. 3, a twelve fiber optical fiber buffer encasement embodiment is shown with the twelve optical fibers 31, encased and embedded in a soft acrylate matrix 32. Again, the elements in the figures are not drawn to scale. Surrounding and encasing the soft acrylate matrix is a relatively hard acrylate encasement layer 33. Together, the optical fibers, the acrylate matrix, and the acrylate encasement layer, comprise a round dual layer optical fiber buffer encasement. The optical fiber buffer encasement is a subunit of the optical fiber seismic sensing cable. In this embodiment the optical fiber buffer encasement contains 12 optical fibers, but may contain from 2-24 optical fibers. Optical fiber buffer encasements with 4 to 12 optical fibers may be expected to be most common in commercial practice.

The dual-layer acrylate construction of the optical fiber buffer encasement, with the soft inner layer and hard outer layer, functions to minimize transfer of bending and crushing forces to the optical fibers, thus minimizing signal attenuation. Alternatively the optical fiber buffer encasement may have an oval cross section.

The term matrix is intended to mean a body with a cross section of matrix material in which other bodies (optical fibers) are embedded. Encasement is intended to mean a layer that both surrounds and contacts another body or layer.

The soft acrylate matrix and the hard acrylate encasement are preferably UV-curable acrylates. Other polymers may be substituted. The UV-curable resins may contain flame-retardants to improve the overall fire resistance of the cable.

An advantage of using UV-cured acrylates in the dual-layer acrylate buffer encasement is that the cabling operation used to apply UV-cured coatings is rapid and cost effective. The following describes the production of the dual-layer acrylate buffer encasement at high cabling speeds. The method used is to apply the coating material as a prepolymer, and cure the prepolymer using UV light. The dual-layer acrylate coatings are applied in tandem or simultaneously (using a two compartment dual die applicator). In the tandem method, a first coating layer is applied, and cured, and the second coating layer is applied over the cured first layer, and cured. In the simultaneous dual coating arrangement, both coatings are applied in a prepolymer state, and cured simultaneously. The UV curable polyacrylate prepolymers are sufficiently transparent to UV curing radiation, i.e., wavelengths typically in the range 200-400 nm, to allow full curing at high draw speeds. Other transparent coating materials, such as alkyl-substituted silicones and silsesquioxanes, aliphatic polyacrylates, polymethacrylates and vinyl ethers have also been used as UV cured coatings. See e.g. S. A. Shama, E. S. Poklacki, J. M. Zimmerman “Ultraviolet-curable cationic vinyl ether polyurethane coating compositions” U.S. Pat. No. 4,956,198 (1990); S. C. Lapin, A. C. Levy “Vinyl ether based optical fiber coatings” U.S. Pat. No. 5,139,872 (1992); P. J. Shustack “Ultraviolet radiation-curable coatings for optical fibers” U.S. Pat. No. 5,352,712 (1994). The coating technology using UV curable materials is well developed. Coatings using visible light for curing, i.e. light in the range 400-600 nm, may also be used. The preferred coating materials are acrylates, or urethane-acrylates, with a UV photo initiator added.

Examples of coating materials suitable for use in the optical fiber buffer encasement of the cables of the invention are:

| | INNER LAYER | OUTER LAYER |
|---|---|---|
| Example 1 | DSM Desotech DU-1002 | DSM Desotech 850-975 |
| Example 2 | DSM Desotech DU-0001 | DSM Desotech 850-975 |
| Example 3 | DSM Desotech DU-1003 | DSM Desotech 850-975 |

The inner layer and outer layer materials may be characterized in various ways. From the general description above it is evident that the modulus of the inner layer should be less than the modulus of the outer layer. Using the ASTM D882 standard measurement method, the recommended tensile modulus for the inner layer is in the range 0.1 to 50 MPa, and preferably 0.5 to 10 MPa. A suitable range for the outer layer is 100 MPa to 2000 MPa, and preferably 200 MPa to 1000 MPa.

The layer materials may also be characterized using glass transition temperatures. It is recommended that the T_{g} of the inner layer be less than 20 degrees C., and the T_{g} of the outer layer greater than 40 degrees C. For the purpose of this description the glass transition temperature, T_{g}, is the point in at the peak of the tan delta curve.

Suitable aramid yarn for the aramid layer is available from Teijin Twaron BV, identified as 1610 dTex Type 2200 Twaron yarn. The yarn may be run straight or with a twist.

The SCOF cable dimensions are not conventional. A typical diameter for the 12 fiber buffer encasement described above is 0.9 mm. In most embodiments the buffer encasement diameter, for 2 to 12 fibers, will be less than 1 mm. The reinforcing yarn layer and the outer jacket typically add 1.5 to 2.5 mm to the cable diameter. The outer jacket may be, for example, 0.5 to 2 mm. The overall cable diameter is preferably less than 6 mm.

The design of the optical fiber buffer encasements with the SCOF described above contributes to a significantly more flexible cable than is found in comparable optical fiber cables.

Optical fiber seismic cables with more than one optical fiber buffer encasement offer an attractive alternative design, one that produces increased fiber count while still relatively small and compact. Buffer encasements of any number, for example 2-10, can be combined in a single jacket. One such embodiment is shown in FIG. 4 where a multiple encasement SCOF cable is shown with 4 optical fiber buffer encasements 41. This design has a smaller central buffer encasement 42 to yield a total of 52 optical fibers in the SCOF cable. Alternatively, the center space may be occupied by a center strength member. This embodiment of the SCOF cable has an aramid yarn layer 43 and outer jacket 44. The individual optical fibers may be color coded to aid in identifying and organizing the optical fibers for splicing. In the embodiment shown in FIG. 4, the optical fiber buffer encasements may also be coded with markings or color to provide additional aid in identifying and selecting the optical fibers. The compact size of the optical fiber buffer encasement allows for manufacture of smaller cables than typically found in competing cable designs.

The cable design described above may be further modified to add additional crush-resistance, strength and robustness. Such a modified design is essentially the cable of FIG. 4, to which is added a second polymer wrap and a second jacket. The second wrap may be similar to wrap 43, i.e., a wrap of reinforcing tape or yarn, preferably polyaramid although glass yarn could be used. The tape or yarn may be run straight or may be helically twisted. The aramid yarn may be coated with a waterswellable finish that can prevent water penetration down the length of the cable. Other waterblocking provisions, such as tapes, yarns, or powders, may also be used to limit water penetration. The term polymer wrap is intended to describe any elongated polymer material that is wrapped or strung along the cable length. The material may be a tape, a yarn, a mesh, plastic reinforced with fiber (FRP) or glass (GRP), or other suitable choice.

There are other useful cable jacket designs in addition to those just mentioned. For example, an aramid yarn or tape may be combined in a polymer and applied as a single layer. The aramid yarn of tape may be coated with an adhesive to improve bonding within the cable structure.

The second polymer jacket may be similar to jacket 44, and is formed as an encasement around the second wrap. As in the case of jacket 44, suitable polymers are polyethylene, polypropylene, nylon, and other materials adapted for this use. The outer jacket may contain UV stabilizers, in which case it may be unnecessary to add a UV stabilizer to the inner jacket 44.

There are other useful cable jacket designs in addition to those just mentioned. For example, an aramid yarn or tape may be combined in a polymer and applied as a single layer. The aramid yarn or tape may be coated with an adhesive to improve bonding within the cable structure. All of these cable jacket designs may be categorized generically as reinforced polymer cable jackets.

It should be evident from the foregoing description that the buffer encasement comprises a subunit of the cable in the sense that is separately prepared as a subassembly of optical fibers, then cabled with a plurality of buffer encasements in a protective yarn and a protective jacket. The same may be the case for the combination of the buffer encasement subunit and the first polymer wrap and first jacket. These may also comprise a subunit of a larger cable design.

The SCOF cable, with sensing boxes installed, is used and reused as described above. It is not usually installed in a permanent location in the field. Thus it does not have the usual installation aids, like rip-cords, etc.

A typical SCOF cable is a few hundred, e.g., 200, to a few thousand, e.g. 2000 or 3000, meters in length, with sensor boxes installed at regular intervals of 2-30 meters, preferably 5-15 meters, as described earlier. To aid in installing the sensor boxes, the SCOF cable may be marked with fiducial marks, for example one or more “Xs”, at suitable intervals, e.g. every 10 meters, to indicate the positions where the sensor boxes are to be installed.

Another aid for installing the sensor boxes is to include factory provided slits in the cable jacket at each of the intended sensor box locations to facilitate splicing a sensor box to a selected optical fiber in the SCOF cable. Each slit may be approximately 100 to 200 mm, preferably 130 mm to 170 mm, in length along the cable length.

Use of the non-conventional SCOF in the cable results in less material use, smaller drums, lower shipping and handling costs, easier cable deployment, easy access to and identification of fibers. In terms of SCOF performance the smaller, lighter, more flexible SCOF cable described above gives these specific characteristics.

An SCOF cable described above withstands a nominal pull force of 150 N, and peak values up to 1800 N. In addition, no change in attenuation using procedure EC 60794-1-2-E11, before versus after load, with a bend radius of 12.5 mm, and fiber unit bending IEC 60794-1-2-G1, before versus after load, with a bend radius of 10 mm.

Preferred optical properties of the SCOF are:
Cutoff wavelength 1410±50 nm
Mode field diameter @ 1550 nm 6.0±0.5 μm
Max. attenuation @ 1550 nm 0.50 dB/km
Max. attenuation induced by 90° bend and a 1.6 mm radius @ 1550 nm 6.0 dB
Macrobend attenuation by 50 turns around 4 mm radius mandrel @ 1550 nm<0.01 dB
Dispersion @ 1550 nm 4 to 8 ps/nm/km

Various other modifications of this invention will occur to those skilled in the art. All deviations from the specific teachings of this specification that basically rely on the principles and their equivalents through which the art has been advanced are properly considered within the scope of the invention as described and claimed.

1. A seismic optical fiber cable comprising:
at least two optical fibers surrounded by a first strength layer, the optical fibers comprising a core, a cladding and a polymer coating, wherein the core and the cladding have a combined diameter in the range of 75-85 micrometers and the overall diameter of the optical fiber is less than 170 microns,
a polymer jacket surrounding the first strength layer,
a second strength layer surrounding the first polymer jacket, and
a second polymer jacket surrounding the second strength layer.

2. The seismic optical fiber cable of claim 1, wherein at least one strength layer comprises a wrap of reinforcing yarns.

3. The seismic optical fiber cable of claim 1, wherein at least one strength layer comprises a wrap of reinforcing tape.

4. A seismic optical fiber cable comprising:
(a) an optical fiber buffer encasement comprising:
i. at least two optical fibers encased in a polymer matrix, the optical fibers comprising a core, a cladding and a polymer coating, wherein the core and the cladding have a combined diameter in the range of 75-85 micrometers and the overall diameter of the optical fiber is less than 170 microns, the polymer matrix having a first modulus,
ii. a polymer layer encasing the polymer matrix, the polymer layer having a second modulus where the second modulus is greater than the first modulus,
(b) a reinforced polymer cable jacket surrounding optical fiber buffer encasement, the reinforced polymer cable jacket having a round cross section.

5. A seismic optical fiber cable comprising:
(a) a plurality of N optical fiber buffer encasements each of the optical fiber buffer encasements comprising:
i. at least two optical fibers encased in a polymer matrix, the optical fibers comprising a core, a cladding and a polymer coating, wherein the core and the cladding have a combined diameter in the range of 75-85 micrometers and the overall diameter of the optical fiber is less than 170 microns, the polymer matrix having a first modulus,
ii. a polymer layer encasing the polymer matrix, the polymer layer having a second modulus where the second modulus is greater than the first modulus,
(b) a reinforced polymer cable jacket surrounding optical fiber buffer encasement, the reinforced polymer cable jacket having a round cross section.

6. The seismic optical fiber cable of claim 5 wherein N is in the range 2-12.

7. The seismic optical fiber cable of claim 6 wherein the cable jacket includes slits through the cable jacket at spaced positions along the seismic optical fiber cable where sensor boxes are to be installed.

8. The seismic optical fiber cable of claim wherein the spacing between spaced positions is equal and in the range of 2-30 meters.

9. The seismic optical fiber cable of claim 8 wherein the slits are 100-200 mm long.

10. The seismic optical fiber cable of claim 6 wherein the cable jacket is marked with fiducial marks at spaced positions along the seismic optical fiber to indicate positions where sensor boxes are to be installed.

11. The seismic optical fiber cable of claim 10 wherein the spacing between spaced positions is equal and in the range of 2-30 meters.

12. The seismic optical fiber cable of claim 6 further including sensor boxes connected to the seismic optical fiber cable and located at spaced positions along the seismic optical fiber.

13. The seismic optical fiber cable of claim 12 wherein the spacing between spaced positions is equal and in the range of 2-30 meters.

14. The optical fiber cable of claim 6 wherein both the polymer matrix and the polymer layer comprise UV cured acrylates.

15. The optical fiber cable of claim 6 wherein the modulus of the polymer matrix is in the range 0.1 to 50 MPa.

16. The optical fiber cable of claim 6 wherein the modulus of the polymer matrix is in the range 0.5 to 10 MPa.

17. The optical fiber cable of claim 6 wherein the modulus of the polymer layer is in the range 200 MPa to 1000 MPa.

18. The seismic optical fiber cable of claim 6 wherein the cross section of the cable jacket has a diameter of less than 6 mm.

19. The optical fiber cable of claim 6 additionally including:
(d) a second polymer wrap strength layer surrounding the first cable jacket, and
(e) a second cable jacket surrounding the second polymer wrap strength layer, the cable jacket having a round cross section.
